(19) United States
(12) Patent Application Publication
(10) Pub. No.: US 2026/0316489 A1
(43) Pub. Date: Oct. 15, 2026

(54) Rim Fibre Architecture of a Composite Wheel with Improved Performance

(71) Applicant: CARBON REVOLUTION PTY LTD, Waurn Ponds, Victoria (AU)

(72) Inventors: Timothy CORBETT, Victoria (AU); Jayden CHEE, Victoria (AU); Eden KWOK, Victoria (AU); Marcus PRESSER, Victoria (AU)

(73) Assignee: CARBON REVOLUTION PTY LTD, Waurn Ponds, Victoria (AU)

(21) Appl. No.: 19/476,504

(22) PCT Filed: Apr. 17, 2024
(86) PCT No.: PCT/AU2024/050363

§ 371 Date: Oct. 17, 2025

(30) Foreign Application Priority Data
Apr. 20, 2023 (AU) 2023901175

(51) Int. Cl. B60B 5/02; B29C 70/08; B29C 70/20; B29C 70/30; B29L 31/32

(52) U.S. Cl. CPC B60B 5/02; B29C 70/08; B29C 70/202; B29C 70/304; B29L 2031/32; B60B 2360/324; B60B 2360/3412; B60B 2360/3416; B60B 2900/311

(57) ABSTRACT

A rim portion of a composite wheel of a vehicle includes a shaped annulus formed about a central axis of rotation and has a circumferential axis extending circumferentially about the central axis and around the rim portion. The rim portion includes a stacked laminate having a fibre layup pattern of alternating layers of a hoop tow layer including elongate fibre tow having fibres aligned with the circumferential axis and a bias ply layer having at least one fibre ply in which the fibres are oriented at a predetermined angle to the circumferential a burst reinforcement layer in the stacked laminate extending across the main body of the rim portion and having at least one fibre ply with fibres oriented at a predetermined angle to the circumferential axis of the rim portion.

### PRIORITY CROSS-REFERENCE

The present application claim priority from Australian provisional patent application No. 2023901175 filed on 20 Apr. 2023, the contents of which should be understood to be incorporated into this specification by this reference.

### TECHNICAL FIELD

The present invention generally relates to the fibre architecture and layup of the rim portion of a composite wheel that has been configured to have improved/optimised “burst performance” due to improved/optimised buckling mode performance. The invention is particularly applicable to composite carbon fibre wheels for vehicles and/or aeroplanes and it will be convenient to hereinafter disclose the invention in relation to that exemplary application. However, it is to be appreciated that the invention is not limited to that application and could be used on the rim portion of a large variety of wheels.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

A composite wheel generally includes two main sections, a rim portion and a face portion. The rim portion comprises an annulus structure configured to receive and seat a tyre. The face portion includes a hub which is used to fix the wheel to the vehicle, and a connection structure such as a series of spokes or a disc which extends between and interconnects the hub and the rim. Lateral, vertical and torsional loads are transmitted through the tyre to the rim portion of the wheel which then produce bending and torsional stresses in the connection structure.

The Applicant has produced a one-piece composite wheel, which is described, for example, in International Patent Publication WO2010/025495A1. The creation of a one-piece composite wheel generally necessitates use of a separate rim portion mould and associated reinforcement and face portion mould and associated reinforcement. The separate rim and face mould portions are then interconnected in a final moulding process which allows the overall composite wheel to be integrally formed.

A stiff and strong rim portion is desired to provide a mechanically efficient structure having optimal radial impact performance and stiffness to assist in the transmission of loads generated between the tyre and road, through the rim and to the spokes.

In addition, thin-walled rim portions are desirable for composite wheels as these reduce the overall weight of the composite wheel, reduce the material used in the composite wheel, provides improved performance (reduced weight and reduced fuel consumption of a vehicle), and can lead to a more efficient rim and wheel production.

The Applicant's international patent publication WO2019/033169A1 teaches one rim fibre architecture of a composite wheel of a vehicle comprising a stacked laminate having a fibre layup pattern comprising consecutive layers providing a repetition pattern or sequence of the combination of 0°, +33° and −33° fibre orientation angles relative to the circumferential axis of the rim portion which are orientated in a direction which adds strength to the structure of the rim portion of the composite wheel. This stacked laminate is formed from alternating layers of: a hoop tow layer comprising at least one annularly wound elongate fibre tow in which the fibres are substantially aligned with the circumferential axis of the rim portion and thus provides stiffness in the barrel or annulus shape of the rim portion; and a bias ply layer comprising at least one fibre ply in which the fibres are substantially orientated at an angle of preferably around +33° or −33°. Each hoop tow layer constrains the adjacent bias ply layer so that laminate thickness can be controlled.

Whilst this layup has been found to have suitable performance for a number of composite wheel configurations, it has been found that composite wheels that have a thinner-walled rim portions (for example approximately 2.1 to 3.1 mm) can have compromised “burst performance”.

Another wheel layup is taught in United States Patent Publication No. 2022/0161595A1 which teaches a vehicle rim having a fibre composite rim body. The increased strength of this particular rim layup is provided by having at least one outer rim flange area reinforced by at least one fiber bundle which is surrounded by a compression wrap. Whilst this layup concentrates on a reinforcement layup with fibre bundles featuring a compression wrap for the outer flange area of the rim body, the main body of the rim still lacks a specific fibre layup tailored towards burst performance.

During the design and development process for composite wheels, hydrostatic pressure testing pressure/burst testing is conducted on tyres to determine bursting pressure of the composite wheel, to ensure that the tyre and wheel rim are able to operate at an acceptable pressure loading/inflation pressure in use. During “burst performance” testing, a composite wheel has a tyre mounted and hydraulically inflated until the wheel fails and can no longer hold pressure. As can be appreciated, the wheels are inflated pneumatically when used in service at a pneumatic pressure much lower than the ultimate strength. Hydrostatic pressure testing aims to find the ultimate failure pressure, to ensure that the typical wheel/tyre service pressure is much lower than this failure pressure.

During hydrostatic pressure testing composite wheels typically fail destructively via either flange separation or axial tear across the barrel (the main body of the rim portion). It has been found that thin-walled composite wheels and wide barrel (wide rim) composite wheels are susceptible to compressive buckling mode which results in tearing of the laminate across the barrel followed by or simultaneously with circumferential tearing, often with 100% separation of either the inner flange, or complete separation of the barrel, midway along the barrel. This results in failure initiating at a much lower pressure than the laminate would otherwise sustain if compressive buckling could be mitigated, and more preferably avoided under pneumatic compressive loading.

It would therefore be desirable to provide a new or improved rim portion fibre architecture that enables thinner laminate thickness rim portions (barrel sections) to be produced while still maintaining adequate burst performance.

### SUMMARY OF THE INVENTION

A first aspect of the present invention provides a rim portion of a composite wheel of a vehicle that comprises a shaped annulus formed about a central axis of rotation of the composite wheel and having a circumferential axis extending circumferentially about the central axis and around the rim portion, said rim portion comprising a main body, an inner flange at one edge of a width of the rim portion, and an outer flange at an edge of the width of the rim portion opposite the inner flange, and a drop center recess comprising a circumferentially extending recess that is radially aligned relative to the central axis,
wherein said rim portion comprising a stacked laminate having a fibre layup pattern comprising alternating layers of:
   a hoop tow layer comprising elongate fibre tow in which the fibres are substantially aligned with the circumferential axis of the rim portion, the hoop tow layer comprising at least one annularly wound elongate fibre tow; and
   a bias ply layer comprising at least one fibre ply in which the fibres are substantially orientated at an angle of at least one of: +θ₁ or −θ₁ to the circumferential axis of the rim portion, wherein θ₁ is from 26 to 40 degrees;
and wherein the fibre layup pattern of at least the main body of the rim portion includes at least one burst reinforcement layer inserted into or proximate to the midplane of the stacked laminate that substantially extends across the main body of the rim portion, each burst reinforcement layer comprising at least one fibre ply in which the fibres are substantially orientated at an angle θ₂ of 80 to 100 degrees to the circumferential axis of the rim portion.

The present invention provides an improved fibre architecture in the rim portion of the composite wheel for a vehicle that provides improved burst performance compared to the rim fibre architecture taught in the Applicant's international patent publication WO2019/033169A1. The main body of the rim portion is again formed from a laminate stack that comprises consecutive layers providing a repetition pattern or sequence of the combination of 0°, +θ₁° and −θ₁° fibre orientation angles relative to the circumferential axis of the rim portion. However, this rim fibre architecture is configured with improved burst performance through the inclusion of at least one burst reinforcement layer that runs across the main body of the rim portion in the midplane of the fibre layup of the stacked laminate. The burst reinforcement layer preferably comprises at least one ply in which the fibres are substantially orientated at an angle orientated around 90 degrees relative to the circumferential axis of the rim portion (80 to 100 degrees and preferably a 90 degree fibre orientated layer) located at or near the midplane (neutral axis) of the laminate, between and preferably connecting the layup of the inner flange and the layup of the drop center recess.

It should be understood that “inserted into or proximate to midplane of the stacked laminate” means the layer or layers are included in the fibre layup comprising the stacked laminate in the midplane or near the midplane of the stacked laminate. The midplane of the fibre layup or stacked laminate comprises the neutral axis (axial axis or bending axis) at or near the midpoint of the stacked laminate/fibre layup about which the layers above and below bend.

The layers of the stacked laminate making up the parts of the rim portion have fibres that are orientated in a direction which adds strength to the structure of the rim portion of the composite wheel. The hoop tow layer is comprised of at least one annularly wound elongate fibre tow, and therefore provides stiffness in the barrel or annulus shape of the rim portion. Furthermore, each hoop tow layer constrains the adjacent bias ply layer so that the thickness of the stacked laminate can be controlled. A desirable radial impact performance is provided through the use of at least one wound hoop tow layer providing resistance to damage and the laminate structure providing a stacked structure of thin ply layers extending through the thickness of the laminate. Radial impact can also be improved through the absence of butt joins where possible. The use of the hoop tow layer and bias ply layers provide a desirable stiffness to the rim portion.

Applicant notes that the selection of fibre direction of the hoop tow layer and bias ply layer has been carefully designed to provide a synergistic effect between the layers to improve the stability and strength of the overall rim structure. The selected fibre orientation angles in combination with the choice of layer material provide the rim portion with improved impact, durability and stiffness performance. In addition, the midplane (or proximate midplane) layup positioning of the burst reinforcement layer provides a surprisingly effective burst resistance without substantially affecting the strength and stiffness imparted by the hoop tow layer and bias ply layer fibre layup pattern.

Due to the improved mechanical efficiency/performance, a thinner rim laminate may be possible compared to other current carbon fibre wheel architectures, leading to a comparatively lighter wheel. As previously noted, a thinner rim provides advantages in weight reduction of the composite wheel, reduction in the material used in the wheel, can have improved performance (reduced weight and reduced fuel consumption of a vehicle), and can result in a more efficient rim and wheel production.

It should be understood that the term composite herein denotes any type of composite material comprising fibres, cured or uncured, irrespective of the structure being layered or not. Furthermore, pre-forms and pre-consolidated pre-forms cured or uncured are important subgroups of composite materials and bodies.

It should also be understood that tows or fibre tows are bundles of a large number of individual fibres, for example 1000's, 10000's or 100000's of fibres. Tow-pregs are at least partially impregnated fibre tows. Accordingly, the hoop tow layer comprises a tow/fibre tow which is annularly wound around the annulus shape of the rim portion to form at least one hoop of aligned fibres therein about the central axis. In preferred forms, the hoop tow layer comprises a hoop wound layer formed from a longitudinally elongate tow that is annularly wound multiple times around the annulus shape of the rim portion.

It should also be understood that ply or plies refers to a sheet or layer of fibres formed or otherwise connected together. A bias ply therefore refers to a sheet or layer of fibres in which the fibres are orientated (or biased) in a specific direction within that sheet. Bias plies typically substantially comprise unidirectional fibres i.e. fibres aligned or orientated in a single direction-along or parallel to a single axis.

It is also to be understood that a pre-form is a composite material comprising fibres. In some instances the preform may also include an uncured matrix material such as a resin. Some preforms may substantially comprise dry fibres with no matrix material. A binder may be used to assist holding the plies together before the matrix material has been injected.

A wide variety of fibres may be used in the present invention, including but not limited to fibres selected from the group consisting of carbon fibres, glass fibres, aramid fibres, synthetic fibres such as acrylic, polyester, PAN, PET, PE, PP or PBO-fibres, or the like, bio fibres such as hemp, jute, cellulose fibres, or the like, mineral fibres for example Rockwool or the like, metal fibres for example steel, aluminium, brass, copper, or the like, boron fibres or any combination of these. In a preferred embodiment, the fibres used in the stacked laminate (and fibre layup thereof) comprise carbon fibres.

The fibres in parts of the layup (where not specifically specified) may be provided in any suitable form including in prepregs, semi-pregs, woven or non-woven fabrics, mats, pre-forms, pre-consolidated pre-forms, individual or groups of fibres, tows, tow-pregs, or the like. The fibres are preferably provided in layers of oriented fibres, for example individual or groups of fibres, fibre tows, fibre tow-pregs, prepregs, semi-pregs, woven or non-woven fabrics or mats as specified.

It is to be understood that prepreg refers to a substantially or fully impregnated collection of fibres, fibre tows, woven or non-woven fabric or the like. Similarly, it is to be understood that semi-preg refers to a partially impregnated collection of fibres or fibre tows. The partial impregnation provides for enhanced removal of gas through or along the dry fibres during consolidation and/or curing. An example of a semi-preg is a partially impregnated layer of fibres.

It is to be understood that woven and non-woven fabrics are collections of individual fibres or fibre tows which are substantially dry, i.e. not impregnated by a matrix material, such as resin.

Finally, it should be understood that the main body of the rim portion comprises the section of the rim portion that extends between the drop center recess (typically located adjacent or proximate to the outer flange) and the inner flange. The main body of the rim portion is typically formed with the thinnest laminate thickness of the stacked laminate comprising the rim portion, and thus can be referred to as the thin barrel region of the stacked laminate.

The hoop tow layer provides a fibre orientated or aligned with the circumferential axis of the rim portion. This provides hoop strength to the rim portion. The bias plies provide angled orientated or aligned fibres, providing lateral strength reinforcement to the structure of the rim. The angle θ₁ to which those fibres are angled away from the circumferential axis of the rim portion is between 26° to 40°. In embodiments, angle θ₁ is from 28° to 40°, preferably 30° to 36°, more preferably about 33°, and yet more preferably 33°. The optimal angle can of course be determined by finite element analysis of a model of the rim portion and composite wheel. The specific angle θ₁ used is dependent on the overall configuration of the composite wheel and the rim portion and requisite loadings and the like.

The hoop tow layer and the bias ply layer comprise aligned fibres, i.e. fibres aligned in a particular direction within the rim portion of the composite wheel. These aligned fibres provide a fibre direction to the rim portion in the direction the aligned fibres of those layers extend relative to the circumferential axis of the rim portion. It should be appreciated that the term “fibre volume fraction” denotes the percentage of total fibres in the stacked laminate that has a fibre direction aligned in any particular direction. Each particular fibre direction can then comprise a fraction (from 0 to 100% depending on overall fibre direction in the stacked laminate) of the total fibre volume. The hoop tow layer preferably provides between 40 to 55%, preferably about 45% of fibre volume fraction in the rim portion. Similarly, the bias ply layer preferably provides between 40 to 55%, preferably about 45% of the fibre volume fraction in the rim portion. The burst reinforcement layer preferably provides 5 to 10% of the fibre volume fraction in the rim portion. In embodiments, this can be achieved by the hoop tow layer comprising between 40 to 55%, preferably about 45% of fibre in the rim portion. Similarly, the bias ply layer may comprise between 40 to 55%, preferably about 45% of the fibre in the rim portion. Again, the burst reinforcement layer preferably provides 5 to 10% of the fibre volume fraction in these embodiments.

The bias plies in the stacked laminate are arranged in the layup to provide alternating angled fibre directions either side of a hoop tow layer. Consecutive bias ply layers are therefore preferably arranged in the layup to provide a layer having a fibre orientation angle that is the (+ or −) alternate angle of the fibre orientation of the preceding bias ply layer. Each bias ply layer is preferably sandwiched between adjacent hoop tow layers. The resulting laminate stack therefore comprises consecutive layers providing a repetition of [0°, +θ₁°, 0°, −θ₁°] fibre orientation angles relative to the circumferential axis of the rim portion.

Bias plies are unidirectional and can be utilised to form over the complex rim geometry whilst still maintaining the requisite fibre alignment/orientation for that layer of the stacked laminate. In some embodiments, the bias plies comprise a sheet of interconnected unidirectional fibre material, preferably interconnected unidirectional tow. That connection can comprise a stitched connection. Such bias plies comprise a stitched unidirectional sheet material, preferably a sheet of stitched unidirectional tow. In some embodiments, a single layer bias ply can be used in the bias ply layer. In other embodiments, the stacked laminate may include two or more layer bias plies in the layup. Some embodiments may include a two layer bias ply comprising a layer having fibre directions of +(26° to 40°) and a layer having fibre directions of −(26° to 40°) relative to the circumferential axis of the rim portion. Each two layer bias ply would be laminated between hoop tow layers in the stacked laminate. At least one layer of hoop tow is therefore located between each bias ply layer. Again, each hoop tow layer constrains the adjacent bias ply layer so that laminate thickness is controlled.

In some embodiments, the bias ply layer comprises at least two fibre plies, comprising at least a first ply in which the fibres are substantially orientated at an angle of +θ₁ or −θ₁ to the circumferential axis of the rim portion, and at least a second ply in which the fibres are substantially orientated at the opposite +θ₁ or −θ₁ angle to the at least first ply, wherein θ1 is from 26 to 40 degrees. In embodiments, this produces a repeating pattern of [0°, +θ₁°, −θ₁°, 0°, +θ₁°, −θ₁°] or [0°, −θ₁°, +θ₁°, 0°, −θ₁°, +θ₁°], for example a repeating pattern of [0°, +33°, −33°], with the at least one burst reinforcement layer inserted into the stacked laminate as described.

In embodiments, each bias ply comprises a continuous sheet from the inner flange of the wheel to the outer flange of the wheel. Each bias ply layer can therefore be preferably formed without butt joins. However, it should be appreciated that in alternate embodiments the bias plies may not be continuous between both flanges. If the bias plies are sufficiently short, they may be preformed as a ‘patch’ of rectangular form that can be picked manually or automatically from a preforming operation and laid up one by one to form a complete layer of bias plies of the same angle on the mandrel. The patches may be overlapped. It should be appreciated that the preforming operation may be that plies are first formed to the correct rim profile using a binder or thermoplastic material that has been pre-applied to the rectangle by clamping the ply in the correct shape and cooling the material to set the binder/thermoplastic material. The preformed rectangular patch can have the hoop wound tow applied. However, other preforming operations could also be utilised.

The hoop tow layer is formed from at least one annularly wound elongate fibre tow. Whilst a single elongate hoop tow could be wound around and about the central axis to form each hoop tow layer, the hoop tow layer can comprise a plurality, preferably multiple annularly wound of elongate fibre tows. The hoop tow layer is preferably spiral wound with the adjacent edges of the concentric hoops of elongate tow abutting.

The at least one burst reinforcement layer preferably provides a fibre orientated or aligned to be perpendicular or close to perpendicular to the circumferential axis of the rim portion. This provides lateral strength in the applied sections across the width of the rim portion. When inserted into or proximate to midplane of the stacked laminate that substantially extends across the main body of the rim portion, the least one burst reinforcement layer improves the burst performance of the composite wheel. The angle θ₂ to which those fibres are angled away from the circumferential axis of the rim portion is between 80° to 100°. In embodiments, the angle θ₂ is from 85° to 95°, preferably 88° to 92°, and more preferably about 90°. In embodiments, the angle θ₂ is 90°.

The at least one burst reinforcement layer preferably comprises at least one ply that extends substantially across the main body of the rim portion of the composite wheel. In embodiments, the at least one burst reinforcement layer comprises a continuous layer, preferably a continuous ply that extends substantially across the main body of the rim portion of the composite wheel. In embodiments, the at least one burst reinforcement layer extends from the inner flange to at least the drop center recess of the rim portion. Preferably, the at least one burst reinforcement layer comprises a continuous ply that extends from the inner flange to at least the drop center recess of the rim portion. The burst reinforcement layer then connects the fibre layup of the inner flange and the drop center recess of the rim portion.

The at least one burst reinforcement layer is preferably laminated between an upper bias ply layer and a lower bias ply layer. In this respect, the at least one burst reinforcement ply is not surrounded or directly adjacent to a hoop tow layer. The at least one burst reinforcement ply is laminated between two bias ply layers. In these embodiments, any hoop tow layer is preferably removed from the midplane of the fibre layup of the main body of the rim portion. This ensures that the hoop tow layer (having fibres orientated at angles at or around 0 degrees) and the burst reinforcement layer or layers (typically comprising fibres with at or around 90 degree orientated fibres) are not laminated adjacent to each other. Thus, in embodiments, the fibre layup is arranged that so that each burst reinforcement layer is not located adjacent a hoop tow layer in the fiber layup pattern. Here, in each location where one or more burst reinforcement layers is needed, hoop tow layers and burst reinforcement layers are arranged in the fibre layup pattern to not be laminated adjacent to each other. This can be preferably achieved by omitting the hoop tow layer from the layup if it falls adjacent a burst reinforcement layer in the layup pattern. Thus, when considering the stacked laminate having a fibre layup pattern comprising alternating layers of: a hoop tow layer; and a bias ply, the burst reinforcement layer or layers is preferably inserted into the fibre layup pattern in place of the hoop tow layer at the midplane or proximate to (close to) the midplane of the stacked laminate.

In embodiments, at least one hoop tow layer is located within the fibre layup at the surfaces farthest away from the midplane of the stacked laminate of the main body of the rim portion. The Inventors have surprisingly found that unidirectional material placed as far from midplane of the stacked laminate (the neutral axial/bending axis at the midpoint of the stacked laminate/carbon fibre layup) as possible produces the largest increase in buckling performance. Therefore, the use of circumferential hoop tow is advantageous when placed at the outer sides of the carbon fibre layup of the stacked laminate.

The fibre layup pattern of each section of the rim portion can be tailored to provide optimised properties for each section. Thus, the rim portion of the carbon fibre wheel can include an overall fibre layup pattern where the fibre layup pattern of the inner flange, the outer flange, the drop center recess, or a combination thereof, is different from the fibre layup pattern of the main body of the rim portion.

For example, the fibre layup pattern of the drop center recess can be different to the fibre layup pattern of the main body of the rim portion. The drop center recess preferably comprises a recessed or trench portion of the rim portion adjacent to but spaced away from the outer safety bead. The recess of the drop portion allows the bead of the tyre to be pushed into the recess of the drop center recess while the other side is pulled over and off the opposing flange.

The recess forming the drop center recess of the rim portion of the composite wheel can be formed by contouring a supporting mould face on which the stacked laminate is formed, and/or through selective or reduced application of hoop tow layers in the drop center recess. In embodiments, the drop center recess comprises a circumferentially extending section/recess having reduced or less tow than sections of the rim portion adjacent to the drop center recess. In embodiments, the drop center recess has reduced or less hoop tow layers than the main body of the rim portion adjacent to the drop center recess. The drop center recess preferably comprises an annular section that is radially extending or radially aligned with the central axis. In embodiments, the drop center recess comprises a recess or trough which extends circumferentially around the rim portion which is radially aligned with the central axis.

The use of reduced hoop tow can in some instances weaken the rim portion in the drop center recess compared to the surrounding layup. The drop center recess therefore preferably includes a strengthening fibre structure, and more preferably a strengthening ply layer. In some embodiments, the rim portion can further comprise at least one reinforcement layer located in the drop center recess. The reinforcement layer preferably comprises a fibre ply having fibres orientated from 80 to 100 degrees to the circumferential axis of the rim portion, preferably about 90 degrees, and more preferably 90 degrees to the circumferential axis of the rim portion. In some embodiments, at least one hoop tow layer is provided over at least the ends of the reinforcement layer. The use of a reinforcement layer is intended to improve wheel performance under biaxial fatigue test loading.

The main body and drop center recess fibre layup patterns will provide substantially different bending strength and stiffness due to the different amounts of hoop tow layers and reinforcement layers (comprising 80 to 100 degrees, preferably 90 degree plies). In order to avoid local stress risers at the intersection of these two fibre layup patterns, the reinforcement layers of the fibre layup pattern of the drop center recess can be terminated in a pattern that spaces apart the ends of each layer within that transition zone, so that there is a gradual change in bending stiffness. In embodiments, the reinforcement layers of the fibre layup pattern of the drop center recess are preferably arranged to terminate in a pattern, preferably a stepped pattern, that provides a gradual change in bending stiffness of the stacked laminate when transitioning from the layup pattern of the drop center recess fibre to fibre layup pattern of the main body.

The fibre layup of the drop center recess can therefore comprise at least one reinforcement layer, preferably multiple reinforcement layers and minimal to no hoop tow, and this creates a structure that is stiff and strong in the bending axis. In the mid barrel region where the laminate is thinnest, there is only one (or very few) burst reinforcement layers (80 to 100 degrees, preferably 90 degree plies) at the midplane of the stacked laminate/fibre layup. This results in the rim portion having a barrel structure that is locally very flexible in the cross barrel bending direction.

The fibre layup pattern of the inner flange and/or the outer flange can also be different to the fibre layup pattern of the main body of the rim portion. Similarly, the fibre layup pattern of other features such as annular beads on the rim can be different to the fibre layup pattern of the main body of the rim portion. In this respect, the rim portion also includes at least one annular bead, preferably two (inner safety bead and outer safety bead respectively spaced apart from the inner flange and outer flange) which extends radially outwardly from the surface of the rim that is spaced apart along the width of the rim from one of the annular flanges. The safety beads are used to retain the inner edge of the tyre onto the rim portion. In embodiments, a fibre layup pattern of at least one of the inner safety bead and the outer safety bead is different from the main body fibre layup pattern.

Features such as the inner flange, outer flange and annular beads and others can be formed as part of the fibre layup of the stacked laminate by aggregating or building up hoop wound tow at selected locations in the layup. In embodiments, the stacked laminate further comprises contoured features formed from aggregated hoop wound tow. The contoured features preferably extend around the circumference of the rim portion and are built up from annularly wound elongate fibre tow. Contoured features that can be formed using aggregated hoop wound tow include at least one bead, flange, rib, or step. The contoured features can therefore comprise the safety beads (i.e. the inner safety bead and the outer safety bead) and the edge flanges (inner flange and outer flange) of the rim portion.

In some embodiments, the layup of at least one of the inner flange or the outer flange includes a reinforcement layer comprising a fibre ply having fibres orientated from 80 to 100 degrees to the circumferential axis of the rim portion, preferably about 90 degrees, more preferably 90 degrees to the circumferential axis of the rim portion. Such additional plies in the inner flange and/or the outer flange assist the prevention of cracking of the laminate in these regions. The reinforcement layer is preferably included in the layup sequence or pattern to provide a hoop tow layer, bias ply layer and reinforcement layer, or a tow layer, bias ply layer tow layer, bias ply layer and reinforcement layer. It should be appreciated that other layup sequences are also possible.

In embodiments, the base region of the layup between the outer flange and drop recess includes a woven fabric having fibre orientation angles relative to the circumferential axis of the rim portion to the bias ply layer. In some embodiments, this woven fabric has a fibre orientation of +(30 to 50), or −(30 to 50) degrees relative to the circumferential axis of the rim portion, preferably +45 or −45 degrees relative to the circumferential axis of the rim portion. Preferably, at least two, preferably three layers of woven fabric are used. In embodiments, this woven fabric forms a part of the connection between the rim portion and the hub portion of the composite wheel.

In embodiments, the outer safety bead is spaced from the outer flange between the outer flange and a radially extending or radially aligned annular section of the drop centre recess, and wherein the at least one burst reinforcement layer extends through the drop centre recess, through the radially extending or radially aligned annular section of the drop centre recess, through the outer safety bead, and towards the outer flange.

The vertical sections or flanges of the contoured shape of the rim portion (i.e. those sections that are radially extending or aligned with the central axis) can be formed with reduced or less tow than sections adjacent thereto for lower inter-laminar tension. In these embodiments, radially extending or aligned sections of the rim portion (relative to the central axis) are formed with reduced or less tow than sections adjacent thereto.

The fibre layup of the rim portion can further include a close out ply layer on at least one outer side of the laminated layer structure, preferably both sides of the laminated layer structure, wherein the closeout ply comprises a sheet of fabric ply, a layer of hoop tow, a bias ply layer, hoop wound fibreglass tow or combination thereof.

In embodiments, the fibre layup pattern of the main body, not including any optional close out ply or capping layer, consists of plies of:
the hoop tow layer comprising the elongate fibre tow in which fibres of the elongate fibre tow are substantially aligned with the circumferential axis of the rim portion, the hoop tow layer being formed from at least one annularly wound elongate fibre tow;
the bias ply layer comprising the at least one fibre ply in which fibres of the at least one fibre ply are substantially orientated at an angle of at least one of: +Θ₁ or −Θ₁ to the circumferential axis of the rim portion, wherein Θ₁ is from 26° to 40°; and
at least one burst reinforcement layer inserted into or proximate to midplane of the stacked laminate that substantially extends across the main body of the rim portion, each burst reinforcement layer comprising at least one fibre ply in which the fibres are substantially orientated at an angle θ₂ of 80 to 100 degrees to the circumferential axis of the rim portion.

The fibre layup or fibre architecture of the rim portion of the present invention comprises a multi-layered structure. The number of layers may vary considerably depending on the design of the rim portion and the size and type of composite members. In some embodiments, only a few layers, for example, 4 to 10 layers, in some embodiments 4 to 20 layers are used. In other embodiments, a higher number, for example 20, 30, 50, 100 or more layers are needed to obtain the desired quality and/or properties of the rim portion.

The fibre density in each layer can be controlled by forming the various layers out of materials of a selected fibre density. The selection of fibre density can influence the mechanical properties of the rim portion and the overall weight. In embodiments, the fibre density in each layer of the stacked laminate is from 50 to 400 g/m², preferably 150 to 300 g/m², more preferably from 180 to 250 g/m², more preferably from 180 to 220 g/m², yet more preferably about 200 g/m². It should be appreciated that the fibre density of the hoop tow layer and bias ply layers can be the same or different. However, it is preferred that the fibre density is at least similar, preferably the same to provide consistent fibre density throughout the rim portion.

It should be appreciated that the rim portion preferably further comprises a matrix material enveloping the fibres of the stacked laminate. The matrix material can comprises a resin based on unsaturated polyester, polyurethane, polyvinyl ester, epoxy, thermoplastics, similar chemical compounds or combinations thereof. However, it should be appreciated other matrix materials may also be applicable.

A second aspect of the present invention provides a composite wheel including a rim portion according to the first aspect of the present invention. The rim portion of the composite wheel is preferably integrally formed with a face portion of the composite wheel.

In some embodiments, the composite wheel is formed about a central wheel axis. The face portion comprises second fibres substantially radially aligned relative to the wheel axis and the rim portion is formed from first fibres substantially axially aligned relative to the wheel axis. A connection between the face portion and the rim portion can be formed from second fibres extending from the face portion axially aligned relative to the wheel axis and first fibres extending from the rim portion axially aligned relative to the wheel axis. Preferably, the rim portion includes an edge flange or a lip portion which extends at an angle relative to the axis. In some embodiments, the first fibres of the connection extend from the edge flange portion of the rim portion.

It should be appreciated that the rim portion comprising fibre architecture/layup according to the first aspect of the present invention can be formed by any suitable process. That process can be a manual layup process, an automated layup process or a combination of manual and automated process. In embodiments, a rim portion of a composite can be formed using the following general process steps:
providing an annular mould tool having an annular mould face shaped to provide the designed configuration of the rim portion;
applying at least one close-out ply layer to the annular mould face;
locating connection elements between a face portion lay-up of the composite wheel and the rim-layup of the composite wheel onto the close-out ply applied to the annular mould face;
depositing alternating layers of hoop tow layer and bias ply layer onto the close-out ply and connection elements to form a stacked multilayer structure, depositing at least one burst reinforcement layer into or proximate to midplane of the stacked laminate that substantially extends across the main body of the rim portion,
thereby forming the rim portion fibre architecture according to the first aspect of the present invention.

It should be appreciated that the close out ply may be a fibre ply sheet or other fibre fabric, or element, or could be formed from hoop tow, as previously discussed.

As noted above, the contours of the rim portion, for example annular safety beads used to retain the inner edges of the tyre in place on the rim portion can be formed using hoop tow windings located and built up into the requite contours and shapes. Furthermore, the inner flange and the outer flange of the rim portion is preferably formed by winding the required hoop tow into the requisite locations on the multilayer structure.

The hoop tow can be located in the layup with a pre-applied binder, preferably powder binder. The powder binder is heated, the tow applied to a previous fibre layer and then cooled so that the powder binder acts as a ‘tackifier’ and the tow is located in the position it is deposited. The tow can be heated via resistive heating.

It is preferred that each of these steps is automated for improved part consistency. Some manual/operator input could be used to set the starting point of tows/plies, or to guide a new layer of bias ply over the layup mandrel and set ply clamps, or the like.

The fibres of the rim portion and/or face portion are preferably injected and/or impregnated with matrix material and then cured and/or set. The method therefore preferably further includes the steps of:
providing a matrix material in contact with each of the layers of the rim portion; and
curing the rim portion.

It should be appreciated that curing of the matrix material and the associate part such as the connection, wheel or similar encompasses curing, setting, drying or similar processes.

The composite wheel is preferably formed as a unitary body. This typically involves simultaneous injection and/or impregnation of matrix material and then curing, setting or the like of each portion of the composite wheel. In such embodiments, each of the rim portion and the face portion are preferably at least partially uncured at the time when the connection therebetween is prepared. The method therefore preferably further includes the steps of:
concurrently providing a matrix material in contact with the rim portion and the face portion of the wheel; and
co-curing the rim portion and the face portion of the composite wheel.

Where the matrix material comprises a resin, a variety of resin delivery systems can be used with the method of the second aspect. In some embodiments, at least a part of the resin is provided by Resin Infusion and/or Resin Transfer Moulding and/or Vacuum Assisted Resin Transfer Moulding.

Once moulded and formed into a composite wheel, the rim portion and the face portion and connection therebetween comprise a matrix material, such as resin, metal, and fibres. During lay-up (preparing up to the point before consolidation and/or setting, curing or the like of the matrix material) of a connection, the matrix material need not be comprised in the layers comprising fibres (e.g. a prepreg or semi-preg) or between the layers comprising fibres. However, the matrix material should form a continuous matrix after setting occurs.

The matrix material need not be comprised in or between two adjacent layers comprising fibres. In a preferred embodiment an adhesive may in this case be provided between at least some of such pairs of layers to at least temporarily and at least partially fix the adjacent layers comprising fibres.

The fibres of the connection, the rim portion and/or the face portion are preferably injected and/or impregnated with matrix material and then cured, set or the like. The connection therefore preferably further comprises a matrix material enveloping the comprising fibres. Any suitable matrix material can be used. In some embodiments, a resin is used. The resin is preferably based on unsaturated polyester, polyurethane, polyvinyl ester, epoxy, thermoplastics, similar chemical compounds or combinations thereof. In a preferred embodiment, the resin is epoxy-based. In other embodiments, the matrix material comprises a metal matrix, forming a composite metal matrix with the fibres when set. The metal matrix material is preferably selected from aluminium, magnesium, titanium, iron and combinations, alloys and mixtures thereof.

### BRIEF DESCRIPTION OF THE DRAWINGS

The present invention will now be described with reference to the figures of the accompanying drawings, which illustrate particular preferred embodiments of the present invention, wherein:

FIG. 1 is a perspective view of a composite wheel including a rim portion according to one embodiment of the present invention.

FIG. 2 is a more detailed view of the rim to face connection region of the composite wheel shown in FIG. 1.

FIG. 3A provides a side view of the rim portion of the composite wheel shown in FIGS. 1 and 2 providing the fibre orientation directions of the rim portion.

FIG. 3B provides a schematic diagram of the pressures on a tyre and connected rim portion of a composite wheel when loaded under distributed air pressure loading during burst performance pressure testing. The amount of tension generated across the barrel laminate is illustrated in the lower thick grey arrows. The amount of tension generated across the tyre is illustrated in the upper thick, dark grey arrows.

FIGS. 4 to 6C provide a cross-sectional schematic representation of the fibre layer layup of various portions of the rim portion of embodiments of the composite wheel shown in FIGS. 1 to 3. A key to the different layers represented in these Figures is provided in FIG. 5(B).

FIG. 7 illustrates the stepped termination of the 90 degree reinforcement layers in the transition zone between the drop center recess fibre layup and the main body layup of the rim portion of the composite wheel illustrated in FIGS. 4 to 6C.

### DETAILED DESCRIPTION

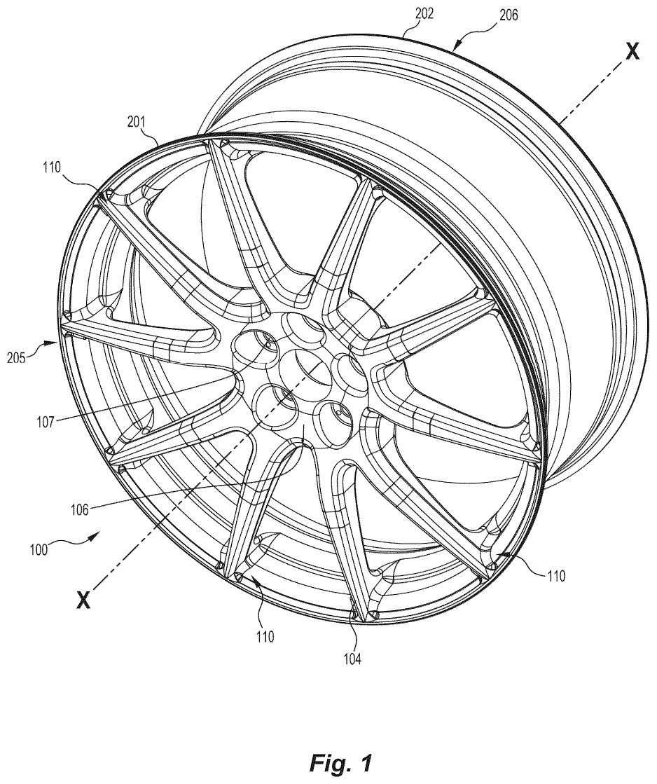

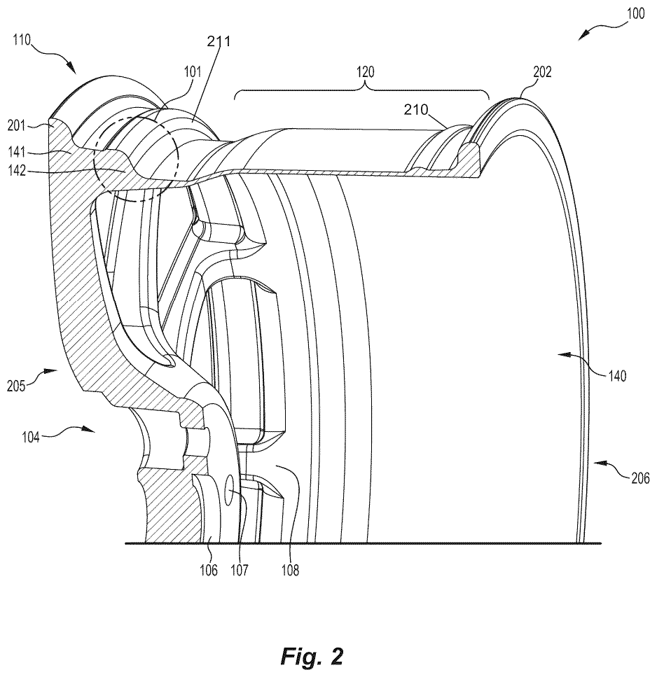

Referring firstly to FIG. 1, there is shown a perspective view of a composite wheel 100 which includes a rim portion 102 according to one embodiment of the present invention. The illustrated composite wheel 100 has been developed by the Applicant as an integrally formed one-piece body. The general process of manufacture of the composite wheel 100 is described in the Applicant's International Patent Publications WO2010/025495A1 and WO2019/033169A1, the contents of which are to be understood to be incorporated into this specification by this reference. It is noted that formation of the rim portion 102 in that publication is modified for the configuration of the present invention by the details provided in the present application.

The illustrated composite wheel 100 includes two main sections:
A). a rim portion 102 that comprises an annulus structure onto which a tyre (not illustrated) is mounted; and
B). a face portion 104 that comprises a central circular hub 106 and a series of spokes 108. The hub 106 includes five fastening apertures 107 configured to receive fastening bolts (not illustrated) used to fix the wheel to a wheel mount of a vehicle. The spokes 108 comprise elongate arms connected to the hub 106 at one end and the rim portion 102 at another end. Whilst a fastening bolt mounting connection is illustrated, it should be appreciated that the hub 106 can be configured for other fastening connections, such as a center mount configuration and other wheel mounting configurations known in the art.

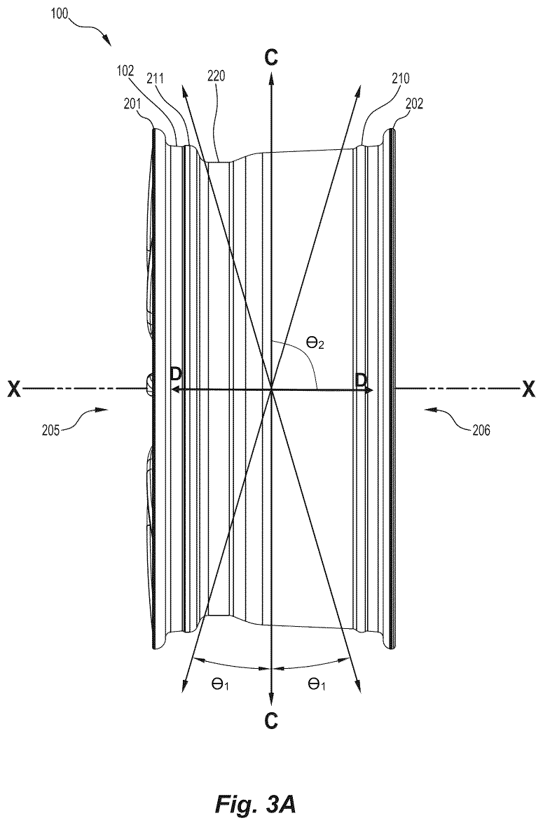

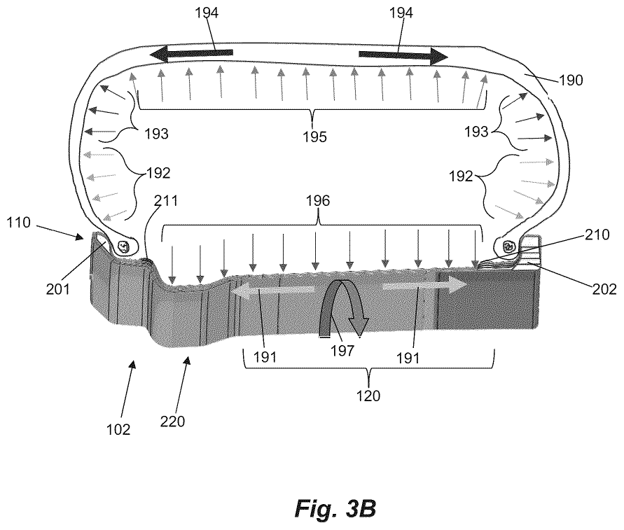

The illustrated rim portion 102 comprises an annulus shaped body formed about a central axis of rotation X-X of the composite wheel 100. As shown in FIG. 3, the rim portion 102 also has a circumferential axis C-C extending circumferentially about the central axis X-X and around the rim portion 102. The rim portion 102 has a series of contoured annular features located along the width of that body. The illustrated rim portion 102 firstly includes two annular flanges 201, 202 that radially extend outwardly from or about the distal edges of the rim portion 106. Those flanges 201, 202 comprise an outer flange 201, which is located on the outer edge 205 of the rim portion 102, at or adjacent to the face portion 104 of the composite wheel 100 and an inner flange 202, located on or at the inner edge 206 of the composite wheel 100, which is located closest to the wheel mount of a vehicle (not illustrated) when mounted on a vehicle. The flanges 201, 202 provide the edge stop members which abut and retain the tyre and tyre walls (not illustrated) onto the rim portion 102 and the composite wheel 100. The rim portion 102 also includes two annular beads, comprising an inner safety bead 210 and outer safety bead 211 which are respectively spaced apart from the inner flange 202 and outer flange 201 of the rim portion 102. The safety beads 210, 211 are used to retain the inner edge of the tyre (not illustrated) onto the rim portion 102. In use, the rim of the tyre wall (not illustrated) is seated between the cooperative flange 201, 202 and safety bead 210, 211.

The illustrated rim portion 102 also includes a drop center recess 220 comprising a recessed or trench portion of the rim portion 102 located in the illustrated embodiment adjacent to but spaced away from the outer safety bead 211. The recess of the drop center recess 220 assists in the fitment and removal of a tyre from the rim portion by allowing the rim or bead of the tyre (not illustrated) to be pushed into the recess of the drop center recess 220 while the other side of the tyre is pulled over and off the opposing flange. It should be appreciated that the recess forming the drop center recess 220 could be positioned anywhere along the width of the rim portion 102, between the two safety beads 210, 211.

Finally, the main body 120 of the rim portion 102 lies between the two annular flanges 201, 202, and between the drop center recess 220 and the inner flange 202. The main body section 120 comprises the long planar section of the rim portion forming the main part of the barrel of the rim portion 102. The main body 120 is generally formed with the thinnest laminate thickness of the stacked fibre laminate comprising the rim portion 120, and thus in some cases may be referred to as the thin barrel region of the stacked laminate.

As described in International Patent Publication WO2010/025495A1, the creation of such a one-piece composite wheel 100 necessitates the use of a separate rim portion mould and face portion mould. In use, the face portion 104 is formed by laying up a first set of fibres, typically embodied in a reinforcement fabric seated in the face portion mould. The rim portion mould includes an inner bucket mould and can use, where applicable, an outer cylindrical mould. The rim portion 102 is formed by laying up a second set of fibres typically embodied in a reinforcement fabric seated in the rim portion mould. The reinforcement fabric from the rim portion mould and the face portion mould are assembled together in a combined mould, with the separate portions being interconnected at a connection point 110. A final moulding process is then undertaken in which matrix material, such as a resin can be injected and/or infused into the reinforcement of the overall wheel form to produce a moulded single piece wheel 100.

As described in International Patent Publication WO2019/033169A1, the spoke to rim connection 110 is formed through the interconnection of the rim reinforcement and face reinforcement of the rim portion 102 and face portion 104 of the composite wheel 100 whilst laying up the rim portion 102. The fibre layup of the rim portion is also laid up after the face portion 104 layup is completed so that the connection between the face portion 104 and 102 can be included directly in the fibre layup of the rim portion 102. The rim portion 102 is formed using a particular rim fibre layup pattern (also known as a “Rim Fibre Architecture”) selected to impart optimised properties to the rim portion 102.

It should be appreciated that when forming the carbon fibre layup of parts of a composite wheel 100, including the rim portion 102, the fibres in each layer of the stacked laminate comprising the fibre architecture can be oriented in any direction between 0° and 180°. It is conventional to refer to fiber orientation beyond 90° as a negative angle value. For example, a 135° fiber angle would be equal to a −45° angle. The way fibres are oriented in a carbon fiber layup significantly influences the resulting properties of the final part. Examples of the different fibre orientations in a carbon fibre wheel relative to the circumferential axis of that wheel is shown in FIG. 3A. As shown by the three main angle directions illustrated in FIG. 3A, most carbon fiber available on the market today utilizes a combination of two or more of the following conventional orientations of carbon fiber layers. In this respect, most parts are not loaded in only one direction, necessitating a mix of the following fiber orientations to suit the required mechanical properties of the part:

0° orientation—This fibre orientation is typically used to provide axial strength and stiffness along an axis, for example along the longitudinal axis of beams and columns that must resist axial or bending loads.

90° orientation—This fibre orientation is typically used to provide transverse strength and stiffness, or where a part bends in two different directions (0 degrees and 90 degrees). For example, for pressure vessels this can be used for creating a consolidating layer that keeps everything together and provides strength in pressure vessels.

±45° orientation—This fibre orientation is traditionally used to provide shear and torsional strength and stiffness for example in torsion shafts and shear webs such as I-beam webs. 45° angles are often used in conjunction with zero and ninety-degree plies to create a quasi-isotropic layup. When used on a tube, 45° layers contribute to twisting stiffness and strength. It should be appreciated that a positive 45° layer is almost always paired adjacently to a negative 45° layer to keep the laminate balanced and from forcefully twisting when loaded.

±33° orientation—This is a variation of the 45° orientation tailored to particular applications, for example curved surfaces. Like the 45° orientation, a positive 33° layer is almost always paired adjacently to a negative 33° layer to keep the laminate balanced and from forcefully twisting when loaded.

Applicant's previous international patent publication No. WO2019/033169A1 describes one rim fibre architecture of a composite wheel of a vehicle comprising a stacked laminate having a fibre layup pattern comprising consecutive layers providing a repetition pattern or sequence of the combination of 0°, +θ° and −θ° fibre orientation angles relative to the circumferential axis of the rim portion which are orientated in a direction which adds strength to the structure of the rim portion of the composite wheel. This stacked laminate is formed from alternating layers of: a hoop tow layer comprising at least one annularly wound elongate fibre tow in which the fibres are substantially aligned with the circumferential axis of the rim portion and thus provides stiffness in the barrel or annulus shape of the rim portion; and a bias ply layer comprising at least one fibre ply in which the fibres are substantially orientated at an angle of at least one of: +θ or −θ to the circumferential axis of the rim portion, wherein θ is from 26° to 40°, and preferably 33 degrees. Each hoop tow layer constrains the adjacent bias ply layer so that laminate thickness can be controlled.

The main body of the rim portion of the carbon fibre wheel described in WO2019/033169A1 is therefore made up of a fibre layup pattern substantially utilising fibres direction around the 0 degrees orientated fibre relative to the circumferential axis of the rim portion (the hoop tow layer) and around the −33 and +33 degrees orientated fibre relative to the circumferential axis of the rim portion (the bias ply layers). The use of the hoop tow layer and bias ply layers provide a desirable stiffness to the rim portion, and also imparts a desirable radial impact performance. This layup also advantageously allows a thinner rim laminate to be formed compared to other current carbon fibre wheel architectures, leading to a comparatively lighter wheel.

Fibre orientated around 90 degrees is not taught as being used in the main body of the rim portion in the fibre layup of the stacked laminate taught in WO2019/033169A1. This fibre orientation is only used as reinforcement layers in areas such as the inner and outer flanges and the drop center recess to impart stiffness to those areas, particularly in regions which include recesses or flanges and thus require additional mechanical strength in the radial direction relative to the central axis). Fibre orientated around 90 degrees is not used in the main body of the rim as this was thought to negatively affect the advantageous properties formed using the alternating hoop tow and bias ply layup.

However, in certain thin walled rim portion (for example ~2.1 to 3.1 mm thickness rim portions) forms, the rim fibre architecture taught in WO2019/033169A1 has been found to have a lower than ideal burst performance (see Background to the Invention). The present invention provides an improvement over that rim fibre architecture that is configured with improved burst performance. In the improved rim fibre architecture of the present invention, the main body of the rim portion is again formed from a laminate stack that comprises consecutive layers providing a repetition pattern or sequence of the combination of 0°, +θ₁° and −θ₁° fibre orientation angles relative to the circumferential axis of the rim portion. However, in this rim fibre architecture improved burst performance is provided by the inclusion of at least one burst reinforcement ply comprising a ply having an angle θ₂ orientated around 90 degrees relative to the circumferential axis of the rim portion (θ₂ is from 80 to 100 degrees and preferably a 90 degree fibre orientated layer) located at or near the mid-plane (neutral axis) of the laminate, between and preferably connecting the layup of the inner flange and the layup of the drop center recess.

The Inventors have discovered from extreme destructive burst studies and finite element analysis of burst failure of the rim portion architecture of a wheel constructed as described in International Patent Publication WO2019/033169A1 that:
the main body 120 of the rim portion 102 performs like a column in buckling under pneumatic compression load. The Inventors have surprisingly found that unidirectional material placed as far from the mid-plane of the stacked laminate (the neutral axial/bending axis at the midpoint of the stacked laminate/carbon fibre layup) as possible produces the largest increase in buckling performance. Therefore, the use of circumferential hoop tow is advantageous when placed at the outer sides of the carbon fibre layup of the stacked laminate of the main body 120 (for example, on both the outer cylindrical mould (rim tool (tyre) side), and the inner bucket/mandrel mould side).
hoop tow placed at or very close to the midplane/middle of the layup of the stacked laminate (neutral axis) results in minimal or no change in buckling stiffness, nor pressure at which the laminate enters or initiates buckling mode.
a 90 degree ply that runs across the main body 120 region of the laminate of the rim portion produces a modest (~5 to 10 psi) improvement in buckling performance when placed at or proximate the mid-plane of the stacked laminate of the main body 120.
Placement of a 90 degree ply at or near the outer surfaces of the stacked laminate, for example near the inner bucket/mandrel mould side at the outer surface of the stacked laminate, removes hoop tow from this location, thereby dramatically reducing buckling mode performance (typically ~25 to 30 psi reduction).
a connecting 90 degree ply across the main body 120 region of the rim portion 102 produces a profound improvement in subsequent failure modes regardless of the laminate position—separation of the inner flange 202 and/or separation of the main body 120 (mid barrel) is generally avoided by the inclusion. Complete separation can be eliminated or dramatically decreased when a 90 degree fibre layer, for example a 90 degree fibre ply, is included across the main body 120 region of the rim portion 102.

Whilst not wishing to be limited by any one theory, the Inventors have counterintuitively discovered that incorporating a small amount of 90 degree material actually helps to counteract buckling mode in the rim of a composite wheel, but only when the 90 degree ply is placed at or near the midplane of the fibre layup of the stacked laminate of the rim portion. In particular, this is advantageous when placed in the laminate across the main body 120 the rim portion 102.

When contemplating normal composite wheel design considerations, the Inventors note that the use of a 90 degree connecting ply or plies across the rim portion 102 of a composite wheel 100 (including the main body 120 of the rim portion 102) would not ordinarily be considered good practice. This can be seen when considering the following free body diagram of an inflated tyre 190 connected to rim portion 102 of a wheel 100 as illustrated in FIG. 3B:

Referring to FIG. 3B, under distributed air pressure loading, the amount of tension generated across the laminate of the rim portion 102 (grey arrows—191) is proportional to the arrow region 192 in the sidewall of the tyre 190. The upper pressure arrows 193 in the sidewall of the tyre 190 are reacted following arrows 194 by cross plies (not illustrated) in the tyre 190.

Distributed air pressure loading in the tyre (arrows 195) is reacted by circumferential plies (not illustrated) in the carcass of the tyre 190, with these plies being loaded in tension.

Distributed air pressure in the barrel (arrows 196) is reacted by circumferential (0 degree) hoop tow in the barrel (arrow 197) loaded in compression. In normal static analysis, the Inventors would conventionally determine that more hoop tow should be applied to the rim portion 102 to counteract this circumferential compressive stress. Furthermore, in the laminate of the rim portion, the Inventors would conventionally determine that there would be some trade-off between managing both loads 191 and 197 simultaneously.

It is understood in design of thin-walled or columnar structures that buckling under compressive load often occurs significantly before the static failure load of a structure. Compressive buckling is a dynamic out-of-plane failure mode whereby the structure deforms in a wave like manner.

The Inventors observe that failure in the rim is found to be dominated and precluded by the compressive buckling mode, whereby the rim laminate enters a wave or buckle formation primarily in the circumferential direction. Once this failure mode is determined, it would be conventional to determine that compressive stiffness in the circumferential direction should be maximised to counteract this buckling. To do this, the fibre layup of the rim portion would be modified to maximise the amount of hoop tow (0 degree fibre orientation aligned in the circumferential axis around the rim portion 102) in the fibre layup of the stacked laminate of the rim portion 102 to provide increased strength and stiffness in the circumferential direction to counteract the buckling mode.

Assuming the barrel thickness is kept constant, any other material added to the fibre layup that is not hoop tow (0 degree fibre orientation) will not result in additional material in the fibre layup in the circumferential direction and would not therefore be expected to contribute to improving circumferential compression strength 197 or improving resistance to compressive buckling mode failure. Removing a layer of hoop tow (0 degree fibre orientation) and replacing it with a layer of such additional material would result in less material with fibres orientated in the circumferential direction and would therefore be expected to reduce circumferential compression strength and stiffness 197, thereby reducing resistance to buckling mode failure. More particularly, the inclusion of 90 degree orientated layers such as 90 degree ply in the place of a layer of hoop tow would be conventionally considered to reduce resistance to compressive buckling mode failure as it replaces the required material in the circumferential direction with a fibre direction which is perpendicular to the loading direction in compressive buckling mode. Including fibres that provide strength and stiffness in this direction (90 degrees—i.e. perpendicular to the circumferential axis of the rim portion) would not be expected to provide any buckling reinforcement properties in the fibre layup.

However, in contrast to this, the Inventors have made the discovery that placing a 90-degree layer (a layer with 90 degree orientated fibres, such as a 90 degree ply) in or close to the mid-plane of the rim portion, and more particularly the middle or midplane of the fibre layup of the main body 120 of the rim portion counterintuitively improves circumferential compressive buckling performance of the rim portion 102. In many cases, this can be achieved by replacing a layer of hoop tow in or close to the mid-plane of the rim portion, with a 90-degree layer. Alternatively, the 90 degree material could also be added at or near the midplane of the fibre layup as an additional layer without removing a layer of hoop tow. This small amount of 90 degree material helps to counteract the buckling mode, but only when the 90 degree ply is placed at or near the midplane of the fibre layup of the stacked laminate of the rim portion.

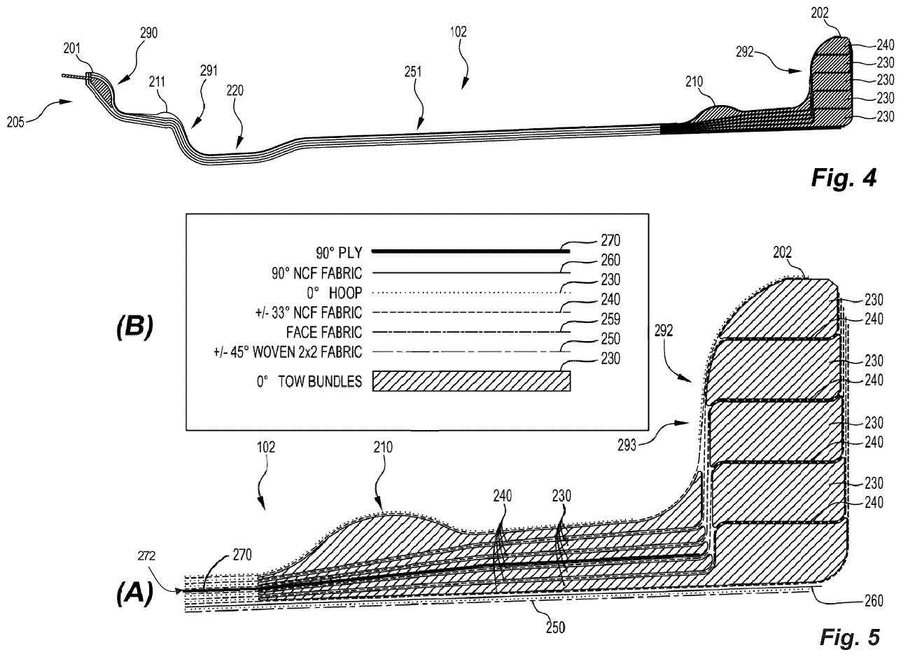

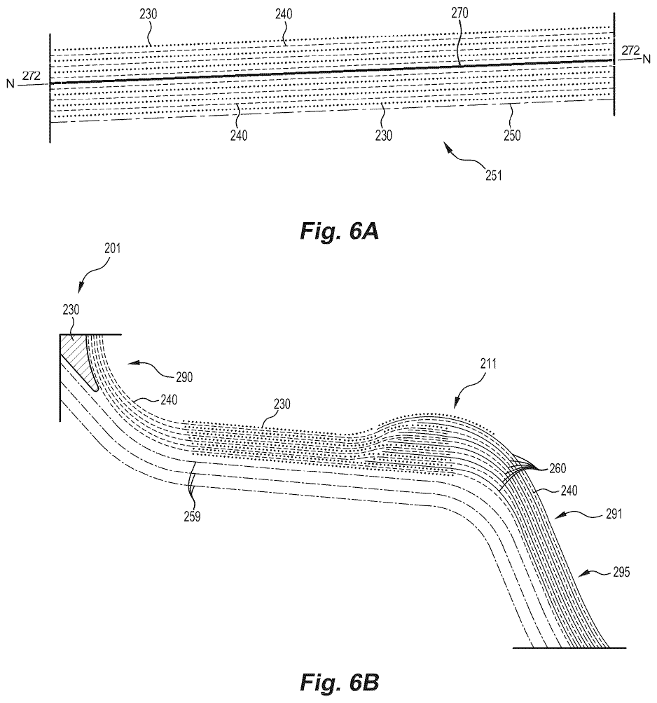

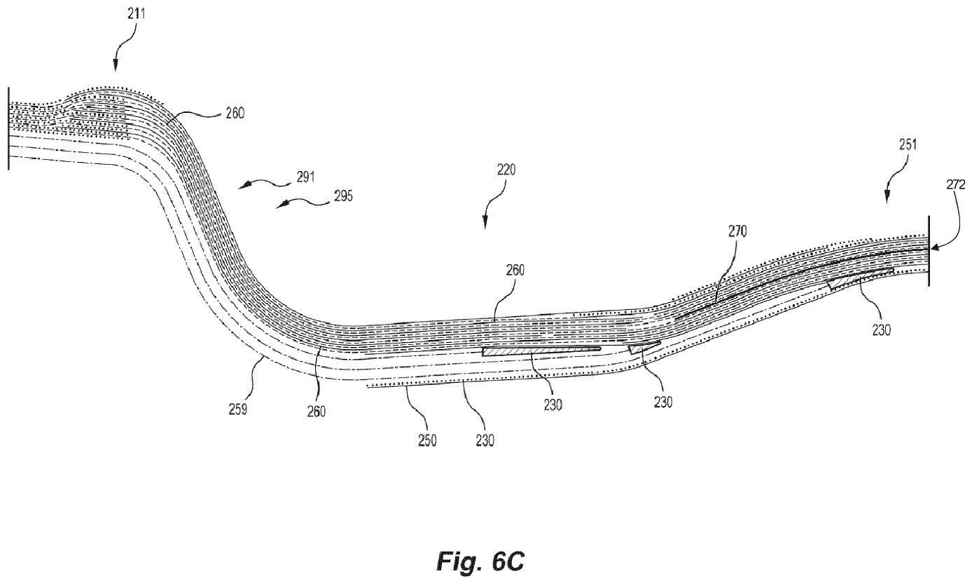

One example of this improved fibre layup of a rim portion 102 is illustrated in FIGS. 4 to 6C. These Figures show cross-sectional views of the rim portion providing a view of the fibre layup of the rim portion 102. As shown in those figures, the rim portion 102 is formed as a stacked laminate of three different fibre layer compositions of:
(1) a hoop tow layer 230 (labelled 0° hoop and 0° tow bundles in key the provided in FIG. 5(B)) comprising elongate fibre tow in which the fibres are substantially aligned with the circumferential axis C-C of the rim portion 102;
(2) a bias ply layer 240 (labelled +/−33° NCF fabric in the key provided in FIG. 5(B)) comprising at least one sheet of fibres (e.g. fibre ply), tow or fabric in which the fibres are substantially orientated at an angle of at least one of: +θ₁ or −θ₁ to the circumferential axis of the rim portion. In the illustrated embodiment, θ₁ is 33°. However, it should be appreciated that θ₁ could be anywhere from 26° to 40° depending on design considerations; and
(3) a burst reinforcement layer 270 (labelled 90 deg plies in key the provided in FIG. 5(B)) inserted into or proximate to midplane of the stacked laminate 272 (shown in FIGS. 5, 6A and 6C as extending through the burst reinforcement layer 270) at or proximate the neutral axis N-N (FIG. 6A) of the stacked laminate 272. The burst reinforcement layer 270 extends across the main body 120 of the rim portion 102. The burst reinforcement layer 270 comprises at least one sheet of fibres (e.g. fibre ply), tow or fabric in which the fibres are substantially orientated at an angle θ₂ of 80 to 100 degrees to the circumferential axis C-C of the rim portion 102. In the illustrated embodiment, the fibres of the burst reinforcement layer 270 are substantially orientated at an angle θ₂ of 90 degrees. However, it should be appreciated that θ₂ could be anywhere from 80 to 100 degrees depending on design considerations.

The hoop tow layer 230 and bias ply layer 240 are stacked as alternating layers in this layup, with the burst reinforcement layer 270 in midplane of the stacked laminate. Each bias ply layer 240 is sandwiched between adjacent hoop tow layers 230 such that each hoop tow layer 230 constrains the adjacent bias ply layer 240 enabling the laminate thickness to be controlled to an extent. The bias ply layers 240 are arranged in the lay up to provide alternating angled fibre directions either side of a hoop tow layer 230. In the illustrated embodiment, consecutive bias ply layers 240 (about a hoop tow layer 230) are therefore arranged in the layup to provide a layer having a fibre orientation angle that is the (+ or −) alternate angle of the fibre orientation of the preceding bias ply layer 240. The resulting laminate stack therefore comprises consecutive layers providing a repetition of [0° (hoop tow layer 230), +θ₁° (bias ply layers 240), 0° (hoop tow layer 230), −θ₁° (bias ply layers 240)] fibre orientation angles relative to the circumferential axis C-C of the rim portion 102 with a burst reinforcement layer 270 inserted into or proximate to midplane of the stacked laminate 272 (shown in FIGS. 5, 6A and 6C as extending through the burst reinforcement layer 270) i.e. at or proximate the neutral axis N-N of the laminate (see FIG. 6A).

Whilst not illustrated, it should be appreciated that in some embodiments, the bias ply layer 240 comprises at least two fibre plies, comprising at least a first ply in which the fibres are substantially orientated at an angle of +θ₁ or −θ₁ to the circumferential axis of the rim portion, and at least a second ply in which the fibres are substantially orientated at the opposite +θ₁ or −θ₁ angle to the at least first ply, wherein θ₁ is from 26 to 40 degrees. In embodiments, the resulting laminate stack therefore comprises consecutive layers providing a repetition of [0° (hoop tow layer 230), +θ₁°, −θ₁° (bias ply layers 240 formed from at least two ply with fiber orientations +θ₁°, −θ₁°), 0° (hoop tow layer 230), +θ₁°, −θ₁° (bias ply layers 240 formed from at least two ply with fiber orientations +θ₁°, −θ₁°)], for example a repeating pattern of [0°, +33°, −33°], or a repeating pattern of [0°, −33°, +33°]. Again, the stacked laminate also with a burst reinforcement layer 270 inserted into or proximate to midplane of the stacked laminate 272 at or proximate the neutral axis N-N of the laminate.

The hoop tow layer 230 provides a fibre orientated or aligned with the circumferential axis C-C of the rim portion 102. This provides hoop strength to the rim portion 102 and stiffness in the barrel or annulus shape of the rim portion 102. The bias ply layer 240 provides angled orientated or aligned fibres, providing strength lateral reinforcement to the structure of the rim. The specific angle θ₁ used is dependent on the overall configuration of the composite wheel and the rim portion and requisite loadings and the like. The inclusion of a burst reinforcement ply 270 that runs across the main body of the rim portion in or near the midplane of that fibre layup provides a reinforcement layer that can help resist buckling performance of the rim portion 102. A key to the line configurations of each of the layers shown in FIGS. 4 to 6C is provided in FIG. 5(B).

The aligned fibres in the hoop tow layer 230 typically provides between 40 to 55% of the fibre volume fraction in the rim portion 102, preferably about 45% of fibre volume fraction in the rim portion 102. Similarly, the bias ply layer 240 typically provides between 40 to 55% of the fibre volume fraction in the rim portion 102, preferably about 45% of the fibre volume fraction in the rim portion 102. The burst reinforcement layer 270 typically provides 5 to 10% of the fibre volume fraction in the rim portion 102.

As shown in FIGS. 4 and 6A, the main body 120 of the rim portion 102 is a laminate stack that comprises consecutive layers providing a repetition pattern or sequence of the combination of 0°, +θ₁° and −θ₁° fibre orientation angles relative to the circumferential axis of the rim portion formed from the hoop tow layer 230 and bias ply layers 240, with a burst reinforcement layer 270 included in midplane of the stacked laminate 272 at or proximate to the neutral axis N-N of the laminate as outlined above.

As shown in FIGS. 4 and 6A, each burst reinforcement layer 170 in the main body 120 is laminated between an upper bias ply layer 240 and a lower bias ply layer 240 to ensure that each burst reinforcement ply 270 is not surrounded or directly adjacent to a hoop tow layer 230. Any hoop tow layer 230 is removed from the midplane of the fibre layup of the main body 120 to ensure that the hoop tow layer 230 and the burst reinforcement layer 270 are not laminated adjacent to each other. This is typically achieved by omitting the hoop tow layer 230 from the layup if it falls adjacent a burst reinforcement layer 270 in the layup pattern.

The inner flange 201, the outer flange 202, the inner safety bead 210 and the outer safety bead 211 and drop center recess 220 of the composite wheel 100 have different layup configurations, described in more detail below.

As described and illustrated in the Applicant's international patent publication WO2019/033169A1, each hoop tow layer or “hoop wound tow layer” 230 is formed from an annularly wound elongate fibre tow which is wound around an inner bucket mould of the rim mould (not illustrated). That elongate fibre tow is wound in hoops around the inner bucket mould and along the width thereof to form the desired thickness and contours of each hoop tow layer 230. The resulting layer comprises a series of overlapping and concentric hoops of the elongate fibre tow 232.

As described and illustrated in the Applicant's international patent publication WO2019/033169A1, each bias ply layer 240 is formed from a sheet of interconnected unidirectional tow that is stitched together to form a sheet. The tow is orientated at the desired angle θ₁ in the sheet. Typically, a single continuous bias tow sheet is laid up from the inner flange 201 to the outer flange 202 of the composite wheel 100 to form the respective bias ply layer 240. Each bias ply layer 240 can therefore be formed without butt joins. However, in alternate embodiments the bias plies may not be continuous between both flanges 201, 202, and could be laid up as smaller patches that are installed (possibly in overlapping mosaic like formation) to form the requisite layer. The patches may be overlapped.

Each burst reinforcement layer 270 may comprise a continuous ply that extends substantially across the main body 120 of the rim portion 102 extending from the inner flange 201 to at least the drop center recess 220 of the rim portion 102 thereby connecting the fibre layup of the inner flange 201 and the drop center recess 220 of the rim portion 102.

It should be appreciated that on wheels with larger tyre sidewalls and/or higher air pressure that more than one 90 degree ply may be needed, and that these 90 degree plies will also preferentially be close to the mid plane or middle of the fibre layup of the stacked laminate of the main body 120.

A close out ply layer 250 (FIG. 5) may be used on the inner side of the rim portion 102, which is first applied to the inner bucket mould of the rim mould (not illustrated). This closeout ply 250 can comprise a sheet of fabric ply, a layer of hoop tow, a bias ply layer, hoop wound fibreglass tow or combination thereof. The fibre layup of the rim portion 102 can also further include at least one capping layer provided over the final applied hoop tow layer of the fibre layup. The capping layer provides a final layer of reinforcement over the outer surface of the fibre layup, and provides a finishing layer preferably matching the outer surface of adjoining sections of the composite wheel. Like the close out ply layer 250, the capping layer can comprise a sheet of fabric ply, a layer of hoop tow, a bias ply layer, hoop wound fibreglass tow, or combination thereof.

The outer end 205 of the layup will also include connection sheets or sections 259 (labelled face fabric in the key provided in FIG. 5(B)) from the fibre layup of the face portion 104 which are integrated in the rim portion layup to securely connect the face portion 104 and rim portion 102 together. As shown in FIG. 6B, these can be part of the base layup from the outer flange 201 through to the drop center recess 220.

Referring again to FIGS. 4 to 6C, it can be observed that the contoured features of the rim portion are formed from a combination of the contoured configuration of a rim mould (not shown) and from being built up from aggregated hoop wound tow. As shown in FIGS. 5 and 6B and 6C, each of the edge flanges 201 and 202 are built up from an aggregated thickness of hoop wound tow 230. In this respect, the hoop tow layer 230 in each of the edge flanges 201 and 202 locations include additional hoop tow windings to build up the contours of the flange 201, 202. Similarly, the inner safety bead 210 and the outer safety bead 211 are built up from an aggregated thickness of hoop wound tow in one of the hoop tow layers 230.

As shown in FIG. 5, the layup of the inner flange 202 includes reinforcement layers (labelled 90° NCF fabric in the key provided in FIG. 5(B)) 260 comprising a fibre ply having fibres orientated from 80 to 100 degrees to the circumferential axis of the rim portion. In the illustrated case, the reinforcement layers 260 comprise a fibre ply fibre ply having fibres orientated 90 degree to the circumferential axis C-C of the rim portion 102. Those reinforcement layers 260 extend in the layup along the vertical or upright sections 293 of the inner flange 202 and extend through to the main section of the rim to the inner safety bead 210. Such reinforcement layers 260 assist the prevention of cracking of the laminate in this region.

The drop center recess 220 is formed from a combination of a moulded shape formed in the contoured shape of the rim mould 280 (and comprising inner bucket mould 310), and through selective or reduced application of hoop tow layers in the drop center recess, forming a thinner or reduced thickness in that area. The drop center recess 220 therefore has less hoop tow windings than sections adjacent to the drop center recess 220. As shown in FIG. 6C, any strength reduction from this lower hoop tow layup can be reinforced through the application of at least one reinforcement layer 260 located in the drop center recess 260. In the illustrated embodiment, this reinforcement layer 260 comprises a fibre ply, typically a fabric formed by stitched tow, having fibres orientated from about 90 degree to the circumferential axis of the rim portion, though it should be appreciated that the fibre alignment could be from 80 to 100 degrees to the circumferential axis C-C of the rim portion 102. As shown in FIG. 6C, reinforcement layers 260 extend in the layup through the drop center recess 220, up through the vertical or upright sections 295 of the drop center recess and extend towards the outer flange 201.

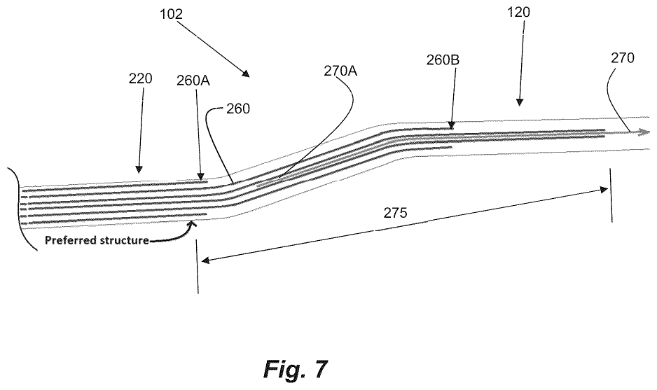

FIG. 7 illustrates the stepped termination of the 90 degree reinforcement layer 260 in the transition zone 275 between the drop center recess 220 fibre layup and the main body layup 120 of the rim portion 102 illustrated in FIGS. 4 to 6C. It should be appreciated that the main body 120 and drop center recess 220 fibre layup patterns will provide substantially different bending strength and stiffness due to the different amounts of hoop tow layers 230 and reinforcement layers 260, 270. In order to avoid local stress risers at the intersection of these two fibre layup patterns, the reinforcement layers 260 of the fibre layup pattern of the drop center recess 220 are preferably terminated in a pattern that spaces apart the ends of each reinforcement layer 260 within that transition zone, so that there is a gradual change in bending stiffness. The initial portion (start) 270A of the burst reinforcement layer 270 is also embedded in the fibre layup of the drop center recess 220 to connect that reinforcement therein. As shown in FIG. 7, the reinforcement layers 260 of the fibre layup pattern of the drop center recess 220 are arranged to terminate in a stepped pattern within transition zone 275 with the ends 260A and 260B of the reinforcement layers 260 of the fibre layup pattern of the drop center recess 220 being spaced apart.

Finally, it should be noted that the radially extending sections or flanges (i.e. those sections that are radially extending or aligned with the central axis) of the contoured shape of the rim portion (for example section 291 in FIGS. 4, 5, 6B and 6C) are formed with reduced or less tow than sections adjacent thereto for lower inter-laminar tension.

The fibre layup or fibre architecture of the rim portion 102 comprises a multi-layered structure. The number of layers may vary considerably depending on the design of the rim portion and the size and type of composite members. In some embodiments, only a few layers, 4 to 10 layer, preferably 4 to 20 layers, for example, 4, 6, 8, 10, 12, 14, 16, 18 or 20 layers are used. In other embodiments, a higher number, for example 20, 30, 50, 100 or more layers are needed to obtain the desired quality and/or properties of the rim portion 102.

It should be appreciated wide variety of fibres may be used in the present invention, including but not limited to fibres selected from the group consisting of carbon fibres, glass fibres, aramid fibres, synthetic fibres such as acrylic, polyester, PAN, PET, PE, PP or PBO-fibres, or the like, bio fibres such as hemp, jute, cellulose fibres, or the like, mineral fibres for example Rockwool or the like, metal fibres for example steel, aluminium, brass, copper, or the like, boron fibres or any combination of these. In a preferred embodiment, the fibres comprise carbon fibres.

The fibre density in each hoop tow layer 230, bias ply layer 240, reinforcement layers 260 and burst reinforcement layers 270 can be controlled by forming the various layers out of materials of a selected fibre density. The fibre density in each layer 230, 240, 260, 270 is from 50 to 400 g/m², preferably from 180 to 250 g/m², more preferably from 180 to 220 g/m², yet more preferably about 200 g/m².

The illustrated composite wheel 100 (FIG. 1) is intended to be formed as an unitary body. This involves simultaneous injection and/or impregnation of a matrix material, which in the exemplary embodiment is a resin, into all parts including the rim portion 102, the face portion 104 and the connection 110 and then curing of each of the portions of the composite wheel 100. The resin used is preferably epoxy-based. However, it should be understood that any suitable resin can be used for example unsaturated polyester, polyurethane, polyvinyl ester, epoxy, thermoplastics, similar chemical compounds or combinations thereof. A variety of resin delivery systems can be used including, but not limited to Resin Infusion and/or Resin Transfer Moulding and/or Vacuum Assisted Resin Transfer Moulding.

The formed rim portion 102 of the composite wheel 100 therefore also comprises a matrix material enveloping the fibres of the stacked laminate, typically a resin based on unsaturated polyester, polyurethane, polyvinyl ester, epoxy, thermoplastics, similar chemical compounds or combinations thereof. However, it should be appreciated other matrix materials may also be applicable.

As described and illustrated in the Applicant's international patent publication WO2019/033169A1, in constructing a composite wheel 100 illustrated in FIG. 1, the composite wheel 100 includes two main mould faces. Firstly, a face mould (not illustrated), which is generally radially orientated relative to the axis of rotation of the wheel X-X. Secondly, an inner bucket mould (not illustrated), which forms the inside face of the rim portion 102. The inner bucket mould includes a front face forming the back mould wall of the face portion which is radially orientated relative to the axis of rotation of the wheel X-X. The inner bucket mould 310 is substantially axially aligned to the axis of rotation of the wheel X-X.

In use, the face portion 104 is laid up with reinforcement with the connection 110 sections for example connection sections or tabs 259 (FIG. 6c).

The rim portion 102 is formed firstly by applying close-out ply or plies (labelled +/−45° woven 2×2 fabric in the key provided in FIG. 5(B)) 250 (if required) to the inner bucket mould 310. The close out ply can comprise a +/−45° biased woven fabric. The inner bucket mould is then combined with the preformed face portion lay-up, face mould. The connection sections 259 connected with the face portion 104 layup are laid onto the close-out ply or plies 250 and a first hoop tow layer 230 is applied over the close-out ply 250 and part of the connection sections or tabs 259. A bias ply layer 240 is then applied, and then alternate layers of hoop tow layer 230 and bias ply layer 240 to build up the rim portion 102 and contoured features thereof as described above. When forming the main body portion 120, at least one burst reinforcement layer 270 is laid in or near the midplane of the layup as a continuous ply that extends substantially across the main body 120 of the rim portion 102 extending from the inner flange 201 to at least the drop center recess 220 of the rim portion 102. That burst reinforcement layer 270 replaces a hoop tow layer 230 in the layup, so is laid up between two bias ply layers 240. Advantageously, the hoop tow 230 holds the bias ply 240 in the correct position against the tooling during layup. It is intended that this process would be reasonably automated, with some operator input to set the starting point of tows/plies, or to guide a new layer of bias ply over the layup mandrel and set ply clamps, or the like. During layup, a layer of bias ply or plies 240 is fed onto the rim mould 280 and a layer of tows is hoop wound thereon to encapsulate the bias ply in the layup and form a hoop tow layer 230. A second layer of bias ply or plies 240 (in the opposite bias i.e. fibre angle θ relative to the circumferential axis C-C) is fed onto the layup so that it covers the previous layer of tows 230. That bias ply layer 240 is then covered with a layer of tows hoop wound thereon to encapsulate the bias ply 230 in the layup and form a hoop tow layer 230. This is repeated until the required laminate thickness is achieved.

The resulting rim layup is a stacked laminate formed from a combination of hoop tows (hoop tow layer 230) and bias plies 240 with the relevant reinforcement layers 260 and hoop reinforcement layer(s) 270 arranged around the face layup, face mould 300 and bucket mould 301. This stacked laminate is presented to a resin injection station (not illustrated) where a vacuum source and resin injection head are connected to a tool assembly and resin is injected and/or impregnated under pressure into a cavity containing the layup. The resin permeates the fibre of the stacked laminate and cures to form a laminated wheel. After demould, the unfinished moulded wheel can undergo finishing procedures (further drilling, surface finishing, coating and the like).

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A rim portion of a composite wheel of a vehicle, the rim portion comprising a shaped annulus formed about a central axis of rotation of the composite wheel and having a circumferential axis extending circumferentially about the central axis and around the rim portion, said rim portion comprising a main body, an inner flange at one edge of a width of the rim portion, and an outer flange at an edge of the width of the rim portion opposite the inner flange, and a drop center recess comprising a circumferentially extending recess that is radially aligned relative to the central axis,
wherein said rim portion comprising a stacked laminate having a fibre layup pattern comprising alternating layers of:
a hoop tow layer comprising elongate fibre tow in which the fibres are substantially aligned with the circumferential axis of the rim portion, the hoop tow layer comprising at least one annularly wound elongate fibre tow; and
a bias ply layer comprising at least one fibre ply in which the fibres are substantially orientated at an angle of at least one of: +θ₁ or −θ₁ to the circumferential axis of the rim portion, wherein θ₁ is from 26 to 40 degrees;
and wherein the fibre layup pattern of at least the main body of the rim portion includes at least one burst reinforcement layer inserted into or proximate to midplane of the stacked laminate that substantially extends across the main body of the rim portion, each burst reinforcement layer comprising at least one fibre ply in which the fibres are substantially orientated at an angle θ₂ of 80 to 100 degrees to the circumferential axis of the rim portion.

2. The rim portion of the composite wheel according to claim 1, wherein the at least one burst reinforcement layer extends from the inner flange to at least the drop center recess of the rim portion.

3. The rim portion of the composite wheel according to claim 1, wherein the at least one burst reinforcement layer comprises a continuous ply that extends from the inner flange to at least the drop center recess of the rim portion.

4. The rim portion of the composite wheel according to claim 1, wherein at least one hoop tow layer is located within the stacked laminate at the surfaces farthest away from the midplane of the fibre layup of the main body of the rim portion.

5. The rim portion of the composite wheel according to claim 1, wherein the at least one burst reinforcement layer is laminated between an upper bias ply layer and a lower bias ply layer.

6. The rim portion of the composite wheel according to claim 1, wherein the fibre layup is arranged that so that each burst reinforcement layer is not located adjacent a hoop tow layer in the fiber layup pattern.

7. The rim portion of the composite wheel according to claim 1, wherein the bias ply layer comprises at least two fibre plies, comprising at least a first ply in which the fibres are substantially orientated at an angle of +θ₁ or −θ₁ to the circumferential axis of the rim portion, and at least a second ply in which the fibres are substantially orientated at the opposite +θ₁ or −θ₁ angle to the at least first ply, wherein θ₁ is from 26 to 40 degrees.

8. The rim portion of the composite wheel according to claim 1, wherein a fibre layup pattern of the inner flange, the outer flange, the drop center recess, or a combination thereof, is different from the fibre layup pattern of the main body of the rim portion.

9. The rim portion of the composite wheel according to claim 1, wherein the drop center recess comprises a circumferential section having a reduced or less hoop tow layers than sections of the rim portion adjacent to the drop center recess, preferably having reduced or less hoop tow layers than the main body of the rim portion adjacent to the drop center recess.

10. A rim portion of a composite wheel according to claim 9, further comprising at least one reinforcement layer located in the drop center recess, said reinforcement layer comprising a fibre ply having fibres orientated from 80 to 100 degrees to the circumferential axis of the rim portion, preferably about 90 degrees to the circumferential axis of the rim portion, optionally y rein ne reinforcement layers of the fibre layup pattern of the drop center recess are arranged to terminate in a pattern that provides a gradual change in bending stiffness of the stacked laminate when transitioning from the layup pattern of the drop center recess fibre to fibre layup pattern of the main body, optionally wherein the pattern comprises a stepped pattern.

11. (canceled)

12. The rim portion of the composite wheel according to claim 9, wherein at least one hoop tow layer is provided over at least the ends of the reinforcement layer.

13. The rim portion of the composite wheel according to claim 1, further comprising at least one of: an inner safety bead spaced from the inner flange and an outer safety bead spaced from the outer flange, wherein a fibre layup pattern of at least one of the inner safety bead and the outer safety bead is different from the main body fibre layup pattern, optionally wherein the outer safety bead is spaced from the outer flange between the outer flange and a radially extending or radially aligned annular section of the drop centre recess, optionally wherein the at least one burst reinforcement layer extends through the drop centre recess, through the radially extending or radially aligned annular section of the drop centre recess, through the outer safety bead, and towards the outer flange.

14. (canceled)

15. A rim portion of a composite wheel according to claim 1, wherein the stacked laminate further comprises contoured features comprising at least one bead, flange, rib, or step that extends around the circumference of the rim portion formed from aggregated hoop wound tow comprising annularly wound elongate fibre tow.

16. A rim portion of a composite wheel according to claim 1, wherein radially extending or aligned sections of the rim portion (relative to the central axis) comprise reduced or less tow than sections adjacent thereto.

17. A rim portion of a composite wheel according to claim 1, wherein the layup of at least one of the inner flange or the outer flange includes a reinforcement layer comprising a fibre ply having fibres orientated from 80 to 100 degrees to the circumferential axis of the rim portion, preferably about 90 degree to the circumferential axis of the rim portion.

18. A rim portion of a composite wheel according to claim 1, further including a close out ply layer on at least one outer side of the laminated layer structure, preferably both sides of the laminated layer structure, wherein the closeout ply comprises a sheet of fabric ply, a layer of hoop tow, a bias ply layer, hoop wound fibreglass tow, or combination thereof.

19. The rim portion of the composite wheel according to claim 1, wherein the fibre layup pattern of the main body, not including any optional closeout ply or capping layer, consists of plies of:
the hoop tow layer comprising the elongate fibre tow in which fibres of the elongate fibre tow are substantially aligned with the circumferential axis of the rim portion, the hoop tow layer being formed from at least one annularly wound elongate fibre tow;
the bias ply layer comprising the at least one fibre ply in which fibres of the at least one fibre ply are substantially orientated at an angle of at least one of: +Θ₁ or −Θ₁ to the circumferential axis of the rim portion, wherein Θ₁ is from 26° to 40°; and
at least one burst reinforcement layer inserted into or proximate to midplane of the stacked laminate that substantially extends across the main body of the rim portion, each burst reinforcement layer comprising at least one fibre ply in which the fibres are substantially orientated at an angle θ₂ of 80 to 100 degrees to the circumferential axis of the rim portion.

20. (canceled)

21. (canceled)

22. (canceled)

23. (canceled)

24. (canceled)

25. (canceled)

26. A rim portion of a composite wheel according to claim 1, wherein the fibres comprise carbon fibres, further comprising a matrix material enveloping the fibres of the stacked laminate, optionally wherein the matrix material comprises a resin based on unsaturated polyester, polyurethane, polyvinyl ester, epoxy, thermoplastics, similar chemical compounds or combinations thereof.

27. (canceled)

28. (canceled)

29. (canceled)

30. A composite wheel including a rim portion according to claim 1.
